(19) United States
(12) Patent Application Publication
(10) Pub. No.: US 2026/0349393 A1
(43) Pub. Date: Nov. 5, 2026

(54) System and method for activating a function of a machine

(71) Applicant: TRUMPF Tracking Technologies GmbH, Ditzingen (DE)

(72) Inventors: Manuel KIEFER, Sinsheim (DE); Christian GÖRG, Moglingen (DE); Eberhard WAHL, Weilheim an der Teck (DE)

(21) Appl. No.: 19/484,487

(22) PCT Filed: Apr. 24, 2024
(86) PCT No.: PCT/EP2024/061279

§ 371 Date: Nov. 14, 2025

(30) Foreign Application Priority Data
May 15, 2023 (DE) 10 2023 112 750.0

(51) Int. Cl. G05B 9/02; G01S 13/02

(52) U.S. Cl. CPC G05B 9/02; G01S 13/0209

(57) ABSTRACT

A system includes a first machine, a mobile operating unit, and a locating system communicatively connected. The locating system is configured to determine the local position of the mobile operating unit. The first machine at least has a first function and a second function and is assigned a first functional region which is locally limited. The first machine is assigned a second functional region which is locally limited different from the first functional region. The mobile operating unit is configured to receive a first activation request to activate the first function or a second activation request to activate the second function from a user via a first user interface. The system is configured to activate the first function of the first machine when at least a first activation condition is fulfilled, and to activate the second function of the first machine when at least a second activation condition is fulfilled.

The invention relates to a system comprising a first machine, in particular a machine tool, a mobile operating unit, and a locating system.

The invention further relates to a method for activating a first function of a first machine or a second function of the first machine.

A method for a locally dependent control access is known from US 2009/065578A1. The invention is based on the object of providing an initially mentioned system and an initially mentioned method that further develop the prior art.

This object is satisfied by a system according to claim 1 and a method according to claim 10.

A system is provided, comprising a first machine, in particular a machine tool, a mobile operating unit, and a locating system, wherein the mobile operating unit, the locating system and the first machine are communicatively connected, wherein the locating system is provided and configured to determine the local position of the mobile operating unit, wherein the first machine at least has a first function and a second function, wherein the first machine is assigned a first functional region, wherein the second functional region is locally limited, wherein the first machine is assigned a second functional region, wherein the second functional region is locally limited, wherein the first functional region and the second functional region are differently locally limited, wherein the mobile operating unit at least has a first user interface, wherein the mobile operating unit is provided and configured to receive a first activation request to activate the first function or a second activation request to activate the second function from a user via the first user interface, and wherein the system is provided and configured to activate the first function of the first machine when at least a first activation condition is fulfilled, and to activate the second function of the first machine when at least a second activation condition is fulfilled, wherein the first activation condition is fulfilled when the mobile operating unit receives the first activation request and the position of the mobile operating unit determined by the locating system is disposed within the first functional region, and the second activation condition is fulfilled when the mobile operating unit receives the second activation request and the position of the mobile operating unit determined by the locating system is disposed within the second functional region.

The first machine thus has two functions that are linked to different local functional regions. The respective assigned function can be activated from the different functional regions. This is in particular useful for functions that can otherwise only be activated at stationary user interfaces so that it is ensured that the user has a view into relevant functional regions.

The mobile operating unit can be a smartphone or a tablet, for example. Mobile means that the operating unit is not fixedly connected to the first machine. The first operating interface can, for example, be a touchscreen. Alternatively or additionally, switches, rotary knobs or other operating elements for manual inputs or a microphone for acoustic inputs are also possible.

The locating system preferably uses a plurality of stationary units and at least one mobile unit, wherein the mobile unit can be a part of the mobile operating unit or can be connected to the mobile operating unit. The locating system is provided and configured to determine the position of the mobile unit relative to the stationary units and thus to determine the position of the mobile operating unit relative to the stationary units. The positions of the stationary units are known in advance so that the position of the mobile operating unit can be determined.

The system preferably includes a computing unit in order to check the activation conditions. For the first activation condition, the computing unit checks whether the position of the mobile operating unit determined by the locating system is disposed within the first functional region and whether the mobile operating unit has received a first activation request. If the first activation condition is fulfilled, the computing unit activates the first function of the first machine. For the second activation condition, the computing unit checks whether the position of the mobile operating unit determined by the locating system is disposed within the second functional region and whether the mobile operating unit has received a second activation request. If the second activation condition is fulfilled, the computing unit activates the second function of the first machine.

The computing unit can be a part of the mobile operating unit, a part of the locating system, a part of the first machine or a stand-alone unit. If the computing unit is a stand-alone unit, the computing unit is communicatively connected to the mobile operating unit, the locating system and the first machine. It is understood that the communicative connection can be direct or indirect. For example, the computing unit can be connected to the mobile operating unit and the mobile operating unit can be connected to the first machine. In this way, the computing unit is communicatively connected to the first machine.

The receipt of the activation request and the determination of the location preferably take place substantially at the same time. The substantial simultaneity can, for example, be defined in that there may at most be a defined time period between the receipt of the activation request and the determination of the location. The fixed time period is preferably five seconds, particularly preferably one second. In a preferred embodiment, a determination of the location is triggered when the activation request is received. It is thereby ensured that a current position is present for the received activation request.

Preferably, the locating system determines the position of the mobile operating unit at regular intervals. A current position of the mobile operating unit is thereby always present. When the first or the second activation request is received, the last determined position or the next determined position can be used to check the first or the second activation condition.

In a preferred embodiment, the first function is a safety-critical function and the second function is a non-safety-critical function or a safety-critical function. A safety-critical function within the meaning of this disclosure is a function whose incorrect operation represents a safety risk. A safety-critical function is in particular a function by which a safety aspect of the machine is confirmed by the user. A safety-critical function is, for example, the closing of a safety circuit of the first machine or the release of a safety zone of the first machine. Locally limited functional regions are in particular advantageous for safety-critical functions that require the user to have a view into specific regions of the first machine. Advantageously, the first functional region is locally limited so that the user has a view into a safety zone of the first machine within the first functional region. It is thereby ensured that the user can only release the safety zone if the user has a view into the safety zone. A non-safety-critical function is a function with no relevance to safety and is thus a harmless function. In particular, the incorrect operation of a non-safety-critical function does not constitute a safety risk. For example, an erroneously triggered emergency stop does not represent a safety risk. A non-safety-critical function is, for example, a data query from the first machine or an order transfer to the first machine. The starting of the first machine can be a non-safety-critical function if the safety is guaranteed by a safety zone to be released.

In a preferred embodiment, at least the activation request for the safety-critical function is transmitted cryptographically signed. In particular, the activation request can be transmitted cryptographically signed between the mobile operating unit and the machine and/or between the mobile operating unit and the computing unit and/or between the computing unit and the machine. Due to the cryptographic signature, the recipient can check whether the activation request was sent by an authorized sender. An activation of the safety-critical function is thus prevented by an unauthorized unit.

In a preferred embodiment, at least the activation request for the safety-critical function is transmitted via two independent communication channels. In particular, the activation request can be transmitted between the mobile operating unit and the machine and/or between the mobile operating unit and the computing unit and/or between the computing unit and the machine via two independent communication channels. Preferably, an activation request for a safety-critical function is transmitted on two independent communication channels and the safety-critical function is only activated if the activation request is received on both communication channels. The use of two independent communication channels provides a higher security of the transmission against communication errors and attacks on the transmission in the case of safety-critical functions. An activation request for a non-safety-critical function, in particular an emergency stop function, is particularly preferably transmitted on two independent communication channels and the non-safety-critical function is activated when the activation request is received on at least one communication channel. The use of two independent communication channels provides a higher security of the transmission against failures of a communication line.

In a preferred embodiment, at least a part of the first functional region is locally disposed within the second functional region. In other words, the two functional regions can overlap or the first functional region can be a part region of the second functional region.

In a preferred embodiment, the first machine has a third function and the mobile operating unit is provided and configured to receive a third activation request to activate the third function and the system is provided and configured to activate the third function when the mobile operating unit receives the third activation request. The third function can be activated independently of functional regions. The third function can be an emergency stop function, for example.

In a preferred embodiment, the mobile operating unit has a second user interface, in particular a push button, and the mobile operating unit is provided and configured to receive the third activation request via the second user interface. Due to the second user interface, a confusion of the third activation request with the first and second activation requests is ruled out. Push buttons are particularly suitable for an emergency stop function so that it can be safely activated at any time.

In a preferred embodiment, the locating system is provided and configured to determine the position of the mobile operating unit using a trilateration of ultra-wideband signals or a triangulation of ultra-wideband signals. A trilateration can be carried out on the basis of time-of-arrival determinations, so-called time-of-arrival (ToA) methods, or time-difference-of-arrival determinations, so-called time-difference-of-arrival (TDoA) methods. In the case of a triangulation, the reception angle of the ultra-wideband signals is determined and a plurality of antennas at the receiving unit are typically used for this purpose.

In a preferred embodiment, the system is provided and configured to receive an authentication of the operator via the mobile operating unit and to check the authentication of the operator when checking the first activation condition. The first function, which can in particular be a safety-critical function, is consequently only activated if the operator has previously authenticated himself.

An authentication-free activation is particularly preferably possible for the third function that can in particular be an emergency stop function. The third function can therefore be activated by any operator.

In a preferred embodiment, the system comprises a second machine, wherein the second machine, the locating system and the mobile operating unit are communicatively connected, wherein the second machine is assigned a third functional region, wherein the third functional region is locally limited, wherein the second machine likewise has the third function, wherein the system is provided and configured to activate the third function on the first machine when the mobile operating unit receives the third activation request and the position of the mobile operating unit determined by the locating system is disposed within the first functional region or within the second functional region, wherein the system is provided and configured to activate the third function on the second machine when the mobile operating unit receives the third activation request and the position of the mobile operating unit determined by the locating system is disposed within the third functional region.

The first machine and the second machine comprise the same, or at least a similar, third function. Depending on the position of the mobile operating unit, the third function is activated on the first machine or the second machine in response to the third activation request. It is not necessary for the user to select the desired machine.

In a preferred embodiment, the system is provided and configured to activate the third function on the first machine and the second machine when the mobile operating unit receives the third activation request and the position of the mobile operating unit determined by the locating system is disposed outside the first, second and third functional region. This embodiment is particularly advantageous if the third function is an emergency stop function. If the desired machine cannot be clearly determined from the position of the mobile operating unit, the emergency stop function is activated on both machines. It is thereby ensured that the emergency stop function is activated immediately after receiving the third activation request.

In an alternative embodiment, the system is provided and configured to offer the first machine and the second machine for selection for activating the third function, in particular via the first user interface or the second user interface, when the mobile operating unit receives the third activation request and the position of the mobile operating unit determined by the locating system is disposed outside the first, second and third function region.

A method for activating a first function of a first machine or a second function of the first machine is provided, wherein a mobile operating unit, a locating system and the first machine are communicatively connected, wherein the first machine at least has the first function and the second function, wherein the first machine is assigned a first functional region, wherein the first functional region is locally limited, wherein the first machine is assigned a second functional region, wherein the second functional region is locally limited, wherein the first functional region and the second functional region are differently locally limited, wherein the mobile operating unit at least has a first user interface, wherein the locating system determines the local position of the mobile operating unit, wherein the mobile operating unit receives a first activation request to activate the first function or a second activation request to activate the second function from a user via the first user interface, wherein the first function of the first machine is activated when at least a first activation condition is fulfilled, and the second function of the first machine is activated when at least a second activation condition is fulfilled, wherein the first activation condition is fulfilled when the mobile operating unit receives the first activation request and the locating system locates the mobile operating unit within the first functional region, and wherein the second activation condition is fulfilled when the mobile operating unit receives the second activation request and the locating system locates the mobile operating unit within the second functional region.

In a preferred embodiment, the first function is a safety-critical function and the second function is a non-safety-critical function or a safety-critical function.

In a preferred embodiment, the locating system is provided and configured to determine the position of the mobile operating unit using a trilateration of ultra-wideband signals or a triangulation of ultra-wideband signals.

The following description of preferred embodiments serves for the more detailed explanation of the invention in conjunction with the drawings.

There are shown:

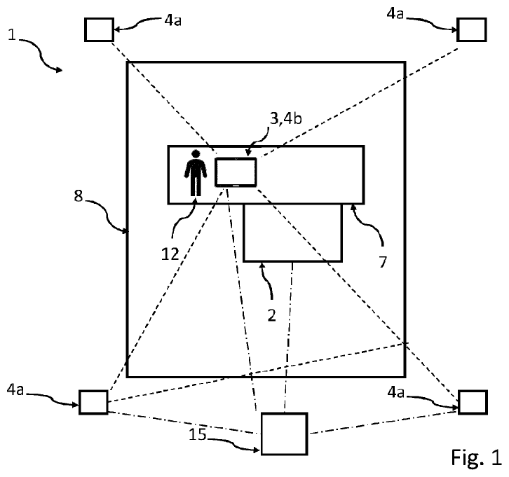

FIG. 1 a System With a First Machine;

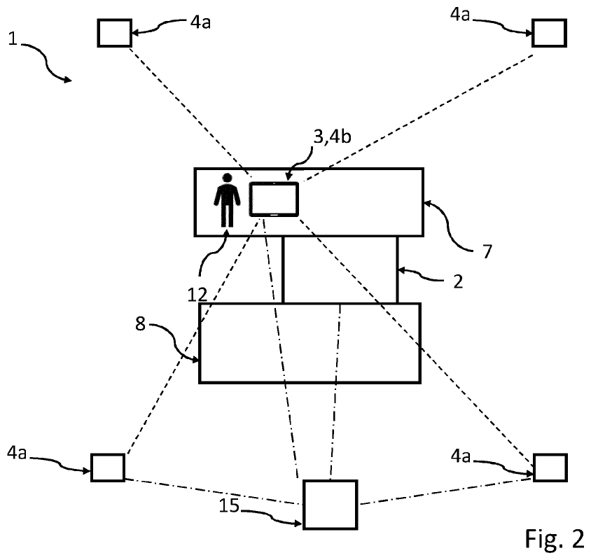

FIG. 2 a further system with a first machine;

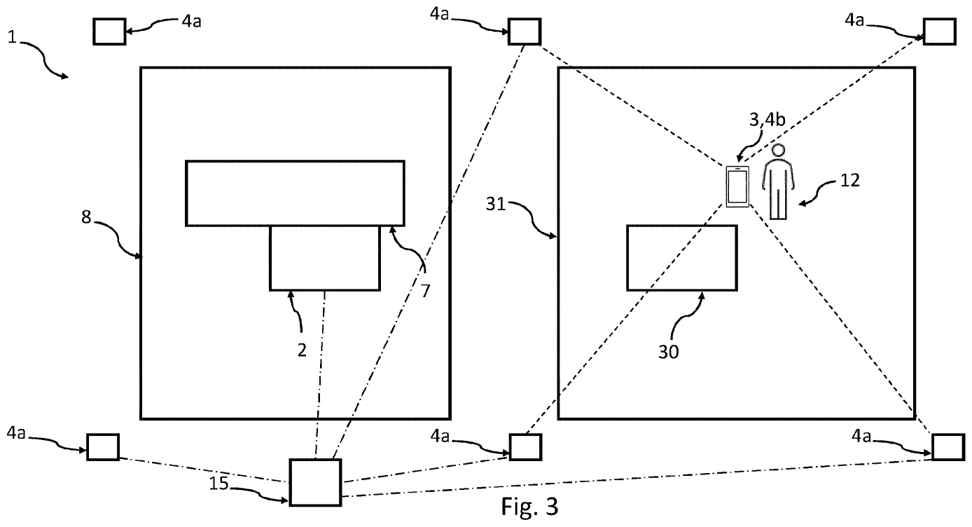

FIG. 3 a system with a first machine and a second machine;

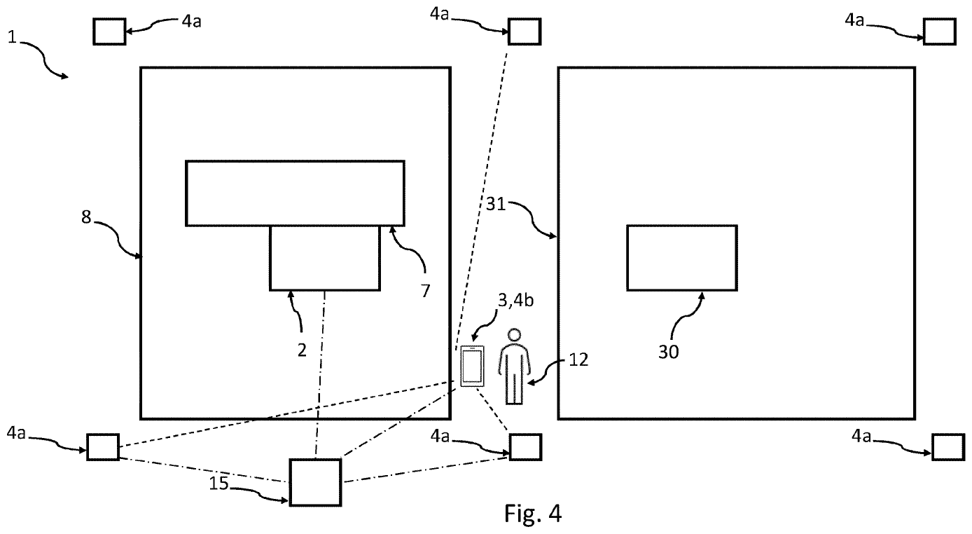

FIG. 4 a further system with a first machine and a second machine;

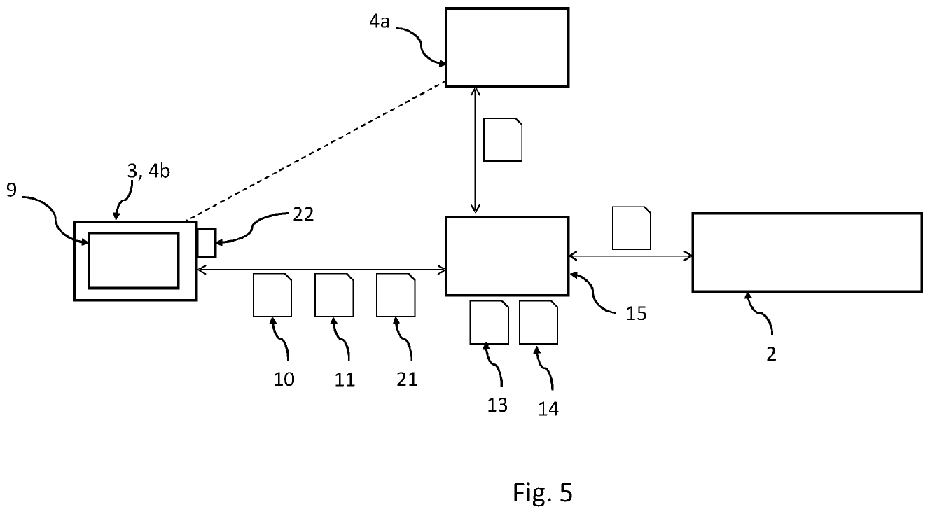

FIG. 5 a schematic view of the communication between the units of the system; and

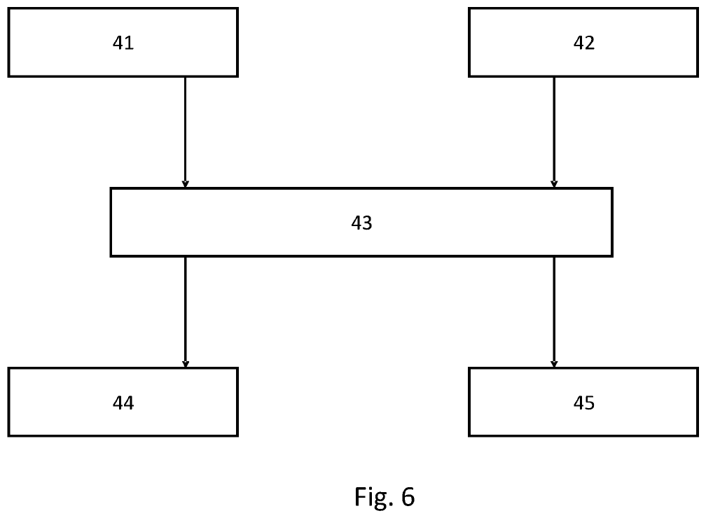

FIG. 6 a sequence of a method.

Elements which are the same or functionally equivalent are designated by the same reference numerals in all the embodiment examples.

An embodiment example of a system is shown in FIG. 1. The system comprises a first machine 2, a mobile operating unit 3 and a locating system 4, wherein the locating system comprises a plurality of stationary units 4a and a mobile unit 4b, in this case the mobile operating unit 3. In this example, a computing unit 15 is also shown. In this example, the computing unit 15 is shown as a stand-alone unit, but it can also be part of the first machine 2, the mobile operating unit 3 or a stationary unit 4a of the locating system 4. The first machine 2 comprises a first functional region 7 and a second functional region 8. In this example, the first functional region 7 is a part region of the second functional region 8. The first functional region 7 is assigned to a first function of the first machine 2 and the second functional region 8 is assigned to a second function of the first machine 2. In this example, the first function of the first machine 2 is the release of a safety zone of the first machine 2. The safety zone may only be released if the user has a clear view into the safety zone. In this example, a clear view is only possible from one side; therefore, the first functional region 7 is only located on one side of the first machine 2. The second function is a harmless function that does not require a clear view into the safety zone; therefore, the second functional region is widely spaced around the first machine 2.

The locating system 4 determines the position of the mobile operating unit 3 at regular intervals. For this purpose, the mobile operating unit 3 transmits ultra-wideband signals, wherein the ultra-wideband signals are received by the stationary units 4a. The position of the mobile operating unit 3 relative to the stationary units 4a is determined by means of a time-difference-of-arrival (TDoA) determination. The positions of the stationary units 4a are known and enable the determination of the position of the mobile operating unit 3. The position of the mobile operating unit is communicated to the computing unit 15.

In this example, the mobile operating unit 3 is disposed within the first functional region 7. The mobile operating unit 3 is a tablet with a touchscreen as the first user interface. A user 12 can, via the first user interface, enter a first activation request to activate the first function or a second activation request to activate the second function. When the user 12 enters an activation request via the first user interface, the activation request is forwarded from the mobile operating unit 3 to the computing unit 15. The computing unit 15 checks whether the first or the second activation condition is fulfilled. The first activation condition is fulfilled when the mobile operating unit 3 receives the first activation request and the position of the mobile operating unit 3 determined by the locating system 4 is disposed within the first functional region 7, and the second activation condition is fulfilled when the mobile operating unit 3 receives the second activation request and the position of the mobile operating unit determined by the locating system is disposed within the second functional region 8. When the first activation condition is fulfilled, the computing unit 15 activates the first function of the first machine 2 and, when the second activation condition is fulfilled, the computing unit 15 activates the second function of the first machine 2. In this example, the user 12 can activate both the first function and the second function from its position shown.

In FIG. 2, a further system 1 comprising a first machine 2 is shown. Only the differences from FIG. 1 are described in the following. Whereas, in the example from FIG. 1, the first functional region 7 is a part region of the second functional region 8, in this example, the first functional region 7 is separate from the second functional region 8. In this example, the mobile operating unit 3 is disposed within the first functional region 7. In contrast to the example from FIG. 1, the user 12 can, from his position shown, activate the first function, but not the second function. In this example, the first function and the second function are safety-critical functions.

When the user 12 enters a first activation request via the first user interface, the first activation request is forwarded cryptographically signed from the mobile operating unit 3 to the computing unit 15. The computing unit 15 then triggers a determination of the position of the mobile operating unit 3 by means of the locating system 4. After receiving the position, the computing unit 15 checks whether the first activation condition has been fulfilled. In this example, the first activation condition is fulfilled and the computing unit 15 activates the first function of the machine 2 via a cryptographically signed message to the machine.

When the user 12 enters a second activation request via the first user interface, the second activation request is forwarded cryptographically signed from the mobile operating unit 3 to the computing unit 15. The computing unit 15 then triggers a determination of the position of the mobile operating unit 3 by means of the locating system 4. After receiving the position, the computing unit 15 checks whether the second activation condition is fulfilled. In this example, the second activation condition is not fulfilled and the processing unit 15 refuses to activate the second function.

In FIG. 3, a system 1 comprising a first machine 2 and a second machine 30 is shown. Only the differences from FIG. 1 are described in the following. In this example, there is a second machine 30 in addition to the first machine 2. The second machine 30 is assigned a third functional region 31. All the functions of the second machine 30 can be activated by the operator 12 via the mobile operating unit 3 when the mobile operating unit 3 is within the third functional region. The check whether the mobile operating unit 3 is disposed within the third functional region takes place analogously to the examples described above.

In FIG. 4, a further system 1 comprising a first machine 2 and a second machine 30 is shown. Only the differences from FIG. 3 are described in the following. In this example, the operator 12 is located outside the functional regions with the mobile operating unit 3. The first machine 2 and the second machine 30 each comprise a third function, in this case an emergency stop of the machine. A third activation request to activate the third function can be entered by the operator 12 via a second user interface of the mobile operating unit 3. When the operator 12 enters a third activation request via the second user interface, the third activation request is forwarded from the mobile operating unit 3 to the computing unit 15. The computing unit 15 checks whether the position of the mobile operating unit 3 is within the first or the second functional region 7, 8 of the first machine 2 and whether the mobile operating unit is disposed within the third functional region 31 of the second machine. In this example, the position of the mobile operating unit 3 is located outside the first, second and third functional region; therefore, the computing unit activates the third function, i.e. the emergency stop, on both machines 2, 30.

The communication between the units of the system 1 is schematically shown in FIG. 5. In this example, the system 1 comprises the first machine 2, the mobile operating unit 3, a stationary unit 4a of the locating system 4 and a computing unit 15. The mobile operating unit 3 is simultaneously a mobile unit 4b of the locating system 4. The mobile operating unit 3 has a first user interface 9, in this case a touchscreen, and a second user interface 22, in this case a push button. The mobile operating unit 3 is able to transmit a first activation request 10, a second activation request 11 and a third activation request 21 to the computing unit 15. The mobile operating unit 3 as the mobile unit 4b of the locating system 4 and the stationary unit 4a of the locating system 4 exchange ultra-wideband messages in order to determine the position of the mobile operating unit 3. The position of the mobile operating unit 3 is transmitted from the locating system 4 to the computing unit 15. The computing unit 15 checks whether the received activation request 10, 11, 21 and the position of the mobile operating unit 3 fulfill the first activation condition 13 or the second activation condition 14. If an activation condition 13, 14 is fulfilled, the computing unit activates the corresponding function of the first machine 2.

A sequence of an exemplary method is shown in FIG. 6. In a first step 41, a first activation request or a second activation request is transmitted. In a second step 42, the position of the mobile operating unit is determined. In a third step 43, it is determined whether the activation request and the position fulfill an activation condition. If a first activation condition is fulfilled, the first function is activated in a fourth step. If a second activation condition is fulfilled, a second function is activated.

### REFERENCE NUMERAL LIST

1 system
2 first machine
3 mobile operating unit
4 locating system
4a stationary unit
4b mobile unit
5 first function
6 second function
7 first functional region
8 second functional region
9 first user interface
10 first activation request
11 second activation request
12 user
13 first activation condition
14 second activation condition
15 computing unit
20 third function
21 third activation request
22 second user interface
30 second machine
31 third functional region
41 first step
42 second step
43 third step
44 fourth step
55 fifth step

1-21. (canceled)

22. A system, comprising a first machine, a mobile operating unit, and a locating system,
wherein the mobile operating unit, the locating system and the first machine are communicatively connected,
wherein the locating system is provided and configured to determine the local position of the mobile operating unit,
wherein the first machine at least has a first function and a second function (6),
wherein the first machine is assigned a first functional region,
wherein the first functional region is locally limited,
wherein the first machine is assigned a second functional region,
wherein the second functional region is locally limited,
wherein the first functional region and the second functional region are differently locally limited,
wherein the mobile operating unit at least has a first user interface,
wherein the mobile operating unit is provided and configured to receive a first activation request to activate the first function or a second activation request to activate the second function from a user via the first user interface, and
wherein the system is provided and configured to activate the first function of the first machine when at least a first activation condition is fulfilled, and to activate the second function of the first machine when at least a second activation condition is fulfilled,
wherein the first activation condition is fulfilled when the mobile operating unit receives the first activation request and the position of the mobile operating unit determined by the locating system is disposed within the first functional region, and
the second activation condition is fulfilled when the mobile operating unit receives the second activation request and the position of the mobile operating unit determined by the locating system is disposed within the second functional region.

23. The system according to claim 22, wherein the first function is a safety-critical function and the second function is a non-safety-critical function or a safety-critical function.

24. The system according to claim 23, wherein the safety-critical function is a function whose incorrect operation represents a safety risk.

25. The system according to claim 24, wherein the first functional region is locally limited so that the user has a view into the safety zone of the first machine within the first functional region.

26. The system according to claim 22, wherein at least a part of the first functional region is locally disposed within the second functional region.

27. The system according to claim 22, wherein the first machine has a third function and the mobile operating unit is provided and configured to receive a third activation request to activate the third function, wherein the system is provided and configured to activate the third function when the mobile operating unit receives the third activation request.

28. The system according to claim 22, wherein the mobile operating unit has a second user interface and the mobile operating unit is provided and configured to receive the third activation request via the second user interface.

29. The system according to claim 22, wherein the locating system is provided and configured to determine the position of the mobile operating unit using a trilateration of ultra-wideband signals or a triangulation of ultra-wideband signals.

30. The system according to claim 22, wherein the system comprises a second machine, wherein the second machine, the locating system and the mobile operating unit are communicatively connected, wherein the second machine is assigned a third functional region, wherein the third functional region is locally limited, wherein the second machine likewise has the third function, wherein the system is provided and configured to activate the third function on the first machine when the mobile operating unit receives the third activation request and the position of the mobile operating unit determined by the locating system is disposed within the first functional region or within the second functional region, wherein the system is provided and configured to activate the third function on the second machine when the mobile operating unit receives the third activation request and the position of the mobile operating unit determined by the locating system is disposed within the third functional region.

31. The system according to claim 22, wherein the system is provided and configured to activate the third function on the first machine and the second machine when the mobile operating unit receives the third activation request and the position of the mobile operating unit determined by the locating system is disposed outside the first, second and third functional region.

32. The system according to claim 22, wherein the system is provided and configured to offer the first machine and the second machine for selection for activating the third function, when the mobile operating unit receives the third activation request and the position of the mobile operating unit determined by the locating system is disposed outside the first, second and third function region.

33. A method for activating a first function of a first machine or a second function of the first machine,
wherein a mobile operating unit, a locating system and the first machine are communicatively connected,
wherein the first machine has at least the first function and the second function,
wherein the first machine is assigned a first functional region,
wherein the first functional region is locally limited,
wherein the first machine is assigned a second functional region,
wherein the second functional region is locally limited,
wherein the first functional region and the second functional region are differently locally limited,
wherein the mobile operating unit at least has a first user interface,
wherein the locating system determines the local position of the mobile operating unit,
wherein the mobile operating unit receives a first activation request to activate the first function or a second activation request to activate the second function from a user via the first user interface,
wherein the first function of the first machine is activated when at least a first activation condition is fulfilled, and
the second function of the first machine is activated when at least a second activation condition is fulfilled,
wherein the first activation condition is fulfilled when the mobile operating unit receives the first activation request and the locating system locates the mobile operating unit within the first functional region, and
wherein the second activation condition is fulfilled when the mobile operating unit receives the second activation request and the locating system locates the mobile operating unit within the second functional region.

34. The method according to claim 33, wherein the first function is a safety-critical function and the second function is a non-safety-critical function or a safety-critical function.

35. The method according to claim 33, wherein at least the activation request for the safety-critical function is transmitted cryptographically signed.

36. The method according to claim 33, wherein at least the activation request for the safety-critical function is transmitted via two independent communication channels.

37. The method according to claim 33, wherein the first machine has a third function and the third function is activated when the mobile operating unit receives a third activation request.

38. The method according to claim 33, wherein the locating system operates using a trilateration of ultra-wideband signals or a triangulation of ultra-wideband signals.

39. The system according to 22, wherein the first machine is a machine tool.

40. The system according to claim 24, wherein the safety risk is one of a closing of a safety circuit of the first machine and the release of a safety zone of the first machine.

41. The system according to claim 28, wherein the second user interface is a push button.

42. The system according to claim 32, wherein the system is provided and configured to offer the first machine and the second machine for selection for activating the third function via the first user interface or the second user interface.
